(19) United States
(12) Patent Application Publication
(10) Pub. No.: US 2025/0191844 A1
(43) Pub. Date: Jun. 12, 2025

(54) MULTILAYER CERAMIC ELECTRONIC COMPONENT

(71) Applicant: Murata Manufacturing Co., Ltd., Nagaokakyo-shi (JP)

(72) Inventor: Satoshi MURAMATSU, Nagaokakyo-shi (JP)

(21) Appl. No.: 19/059,451

(22) Filed: Feb. 21, 2025

Related U.S. Application Data
(63) Continuation of application No. PCT/JP2023/032603, filed on Sep. 7, 2023.

(30) Foreign Application Priority Data
Nov. 22, 2022 (JP) 2022-186398

(51) Int. Cl. H01G 4/232; H01G 4/005; H01G 4/12; H01G 4/248; H01G 4/30

(52) U.S. Cl. CPC H01G 4/2325; H01G 4/005; H01G 4/12; H01G 4/248; H01G 4/30

(57) ABSTRACT

A multilayer ceramic electronic component includes a first outer electrode extending from a first end surface to a portion of a second main surface and a second outer electrode extending from a second end surface to a portion of the second main surface. Each of the first and second outer electrodes includes a thin film layer and a plating layer on the thin film layer. The thin film layers include main surface thin film layers on the second main surface, end surface thin film layers on the first and second end surfaces, and continuous thin film layers continuing in a height direction from the end surface thin film layers, respectively. A thickness of each of the continuous thin film layers in a length direction is smaller than a thickness of each of the end surface thin film layers in the length direction.

### CROSS REFERENCE TO RELATED APPLICATIONS

This application claims the benefit of priority to Japanese Patent Application No. 2022-186398 filed on Nov. 22, 2022 and is a Continuation Application of PCT Application No. PCT/JP2023/032603 filed on Sep. 7, 2023. The entire contents of each application are hereby incorporated herein by reference.

### BACKGROUND OF THE INVENTION

### 1. Field of the Invention

The present invention relates to multilayer ceramic electronic components.

### 2. Description of the Related Art

With the improvement in performance of electronic devices such as mobile phones, notebook computers, and digital cameras in recent years, multilayer ceramic electronic components used in the electronic devices have been required to be reduced in size. In most cases, the multilayer ceramic electronic component includes a multilayer body and an outer electrode. The multilayer body includes an inner layer portion and an outer layer portion. The inner layer portion is formed by alternately laminating multiple ceramic layers and multiple inner electrode layers in a predetermined lamination direction. The outer layer portion is formed by positioning the ceramic layers so as to sandwich the inner layer portion. The multiple inner electrode layers are exposed at both end surfaces of the multilayer body in a width direction orthogonal to the lamination direction. In the multilayer ceramic electronic component of Japanese Unexamined Patent Application Publication No. 2012-182355, the outer electrode includes a base electrode layer electrically coupled to the inner electrode layer exposed from the end surface of the multilayer body, and a plating layer covering the base electrode layer. In the base electrode layer, in order to increase adhesion between the multilayer body and the base electrode layer, a metal occupied area in a section of the base electrode layer on a side of the multilayer body is controlled, and a dielectric material in the base electrode layer is controlled.

### SUMMARY OF THE INVENTION

However, too strong adhesion between the multilayer body and the base electrode layer may cause a crack to occur in the ceramic layer between the inner electrode layer and the base electrode layer due to thermal stress and/or mechanical stress applied to the multilayer ceramic capacitor. In particular, when a measurement of the multilayer ceramic capacitor in a height direction is small, a measurement of the ceramic layer in the height direction in a portion between the inner electrode layer and the base electrode layer becomes very small, and thus, occurrence of a crack in this portion is significant.

Example embodiments of the present invention provide multilayer ceramic electronic components capable of reducing or preventing the occurrence of cracks.

A multilayer ceramic electronic component according to an example embodiment of the present invention includes a multilayer body including multiple laminated ceramic layers, a first main surface and a second main surface opposed to each other in a height direction, a first end surface and a second end surface opposed to each other in a length direction orthogonal to the height direction, and a first side surface and a second side surface opposed to each other in a width direction orthogonal to the height direction and the length direction, multiple first inner electrode layers on the multiple ceramic layers and extended to the first end surface, multiple second inner electrode layers on the multiple ceramic layers and extended to the second end surface, a first outer electrode on the first end surface, extending from the first end surface to be located on a portion of the second main surface, and coupled to the first inner electrode layers, and a second outer electrode on the second end surface, extending from the second end surface to be located on a portion of the second main surface, and coupled to the second inner electrode layers. Each of the first outer electrode and the second outer electrode includes a thin film layer and a plating layer on the thin film layer, the thin film layer of each of the first outer electrode and the second outer electrode includes a main surface thin film layer on the second main surface of the multilayer body, an end surface thin film layer on a corresponding one of the first end surface and the second end surface of the multilayer body, and a continuous thin film layer extending continuously with the end surface thin film layer in the height direction. A thickness of the continuous thin film layer in the length direction is smaller than a thickness of the end surface thin film layer in the length direction.

In an multilayer ceramic electronic component according to an example embodiment of the present invention, the thickness of the continuous thin film layer in the length direction is smaller than the thickness of the end surface thin film layer in the length direction, so that a bonding strength between the continuous thin film layer and the ceramic layer becomes smaller than a bonding strength between the end surface thin film layer and the ceramic layer. This makes it possible to reduce the occurrence of a crack in the multilayer ceramic electronic component when stress such as thermal stress and/or mechanical stress is applied to the multilayer ceramic electronic component.

According to example embodiments of the present invention, multilayer ceramic electronic components each capable of reducing or preventing the occurrence of a crack are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an example of a two-terminal multilayer ceramic capacitor as a multilayer ceramic electronic component according to an example embodiment of the present invention.

FIG. 2 is a sectional view taken along a line II-II in FIG. 1.

FIG. 3 is a sectional view adding a dummy electrode layer to FIG. 2.

FIG. 4 is a partially enlarged view of FIG. 2.

FIG. 5 is a sectional view taken along a line V-V in FIG. 1.

FIG. 6 is a sectional view taken along a line VI-VI in FIG. 2.

FIG. 7 is a sectional view taken along a line VII-VII in FIG. 2.

FIG. 8 is a side view of an example of a mounting structure of a two-terminal multilayer ceramic capacitor according to an example embodiment of the present invention.

FIG. 9A is an external perspective view of a multilayer ceramic capacitor according to a modification of an example embodiment of the present invention, and FIG. 9B is a sectional view of the multilayer ceramic capacitor in FIG. 9A taken along a line IXb-IXb.

### DETAILED DESCRIPTION OF THE EXAMPLE EMBODIMENTS

### 1. Multilayer Ceramic Capacitor

A two-terminal multilayer ceramic capacitor will be described as an example of a multilayer ceramic electronic component according to an example embodiment of the present invention.

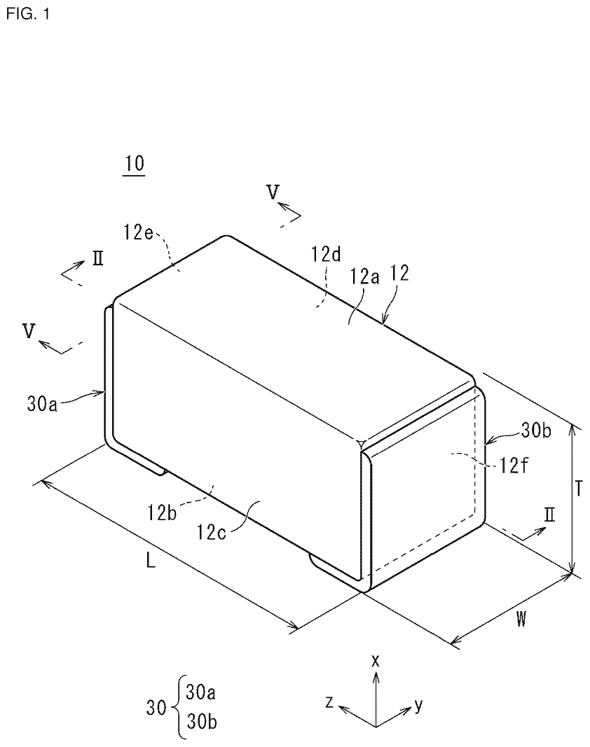

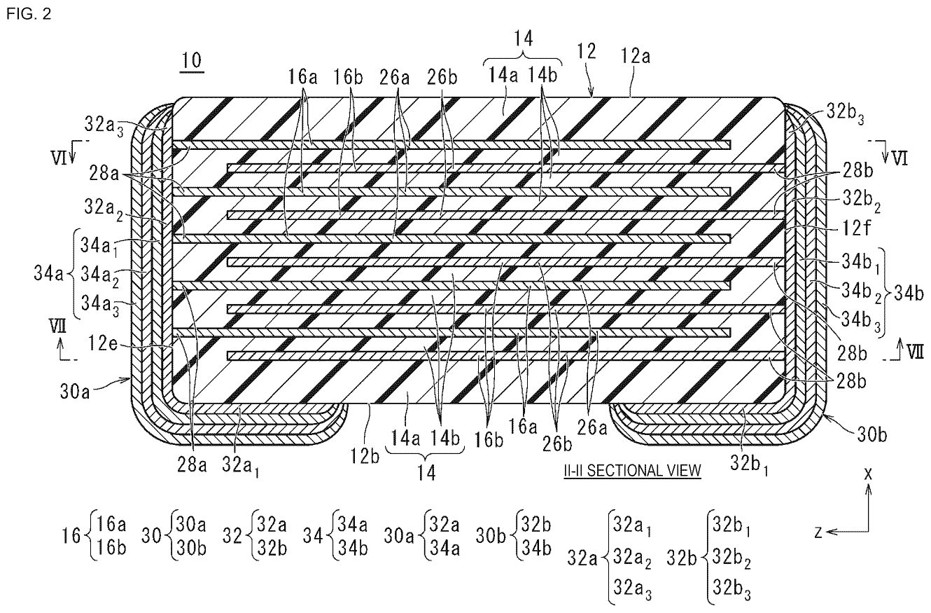

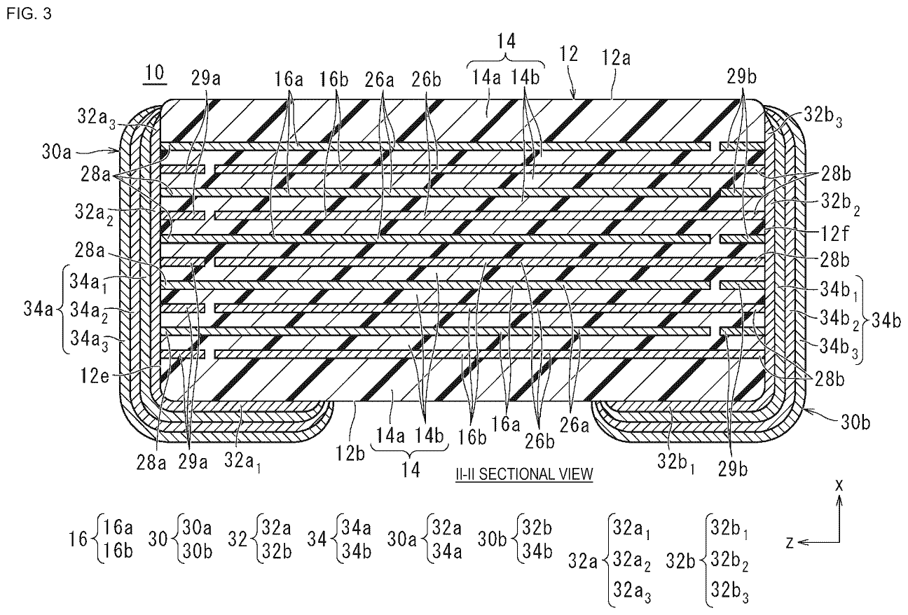

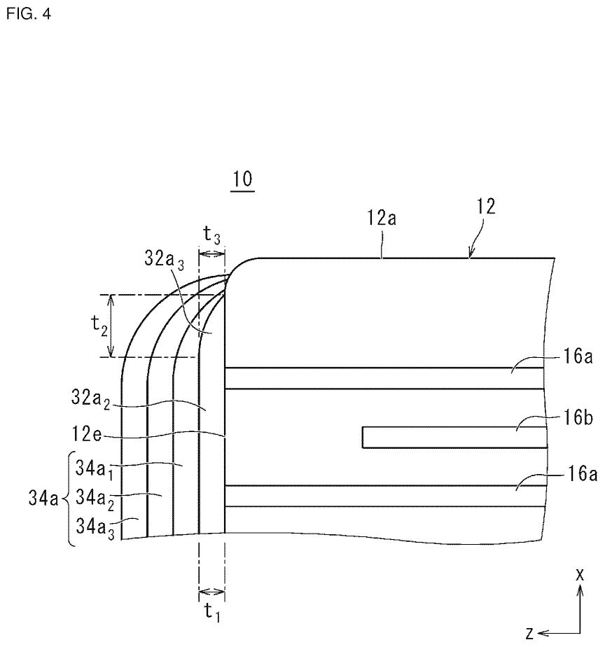

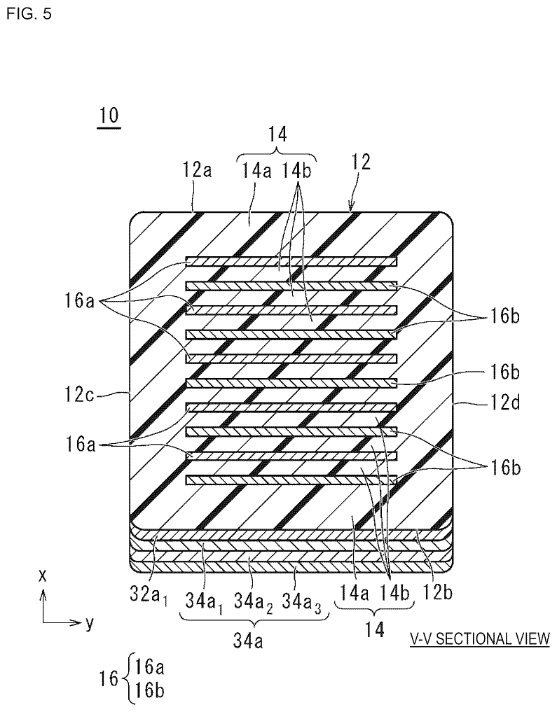

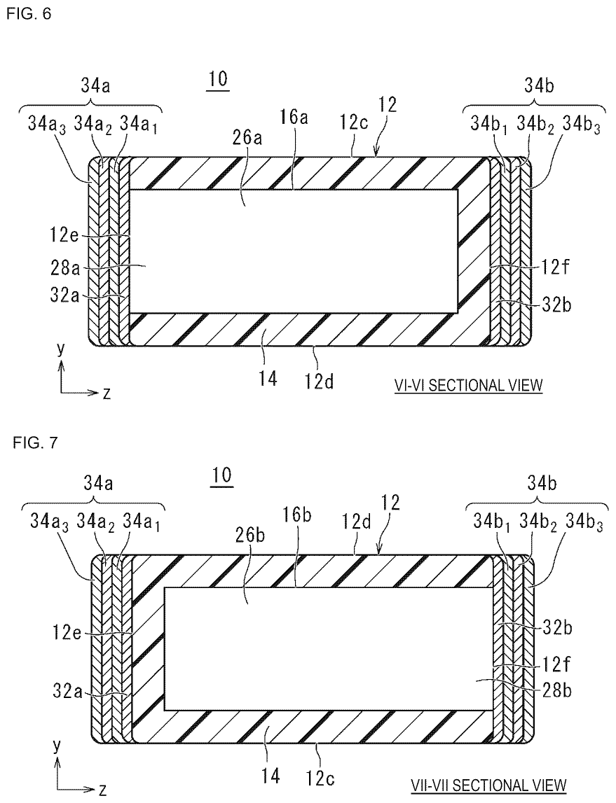

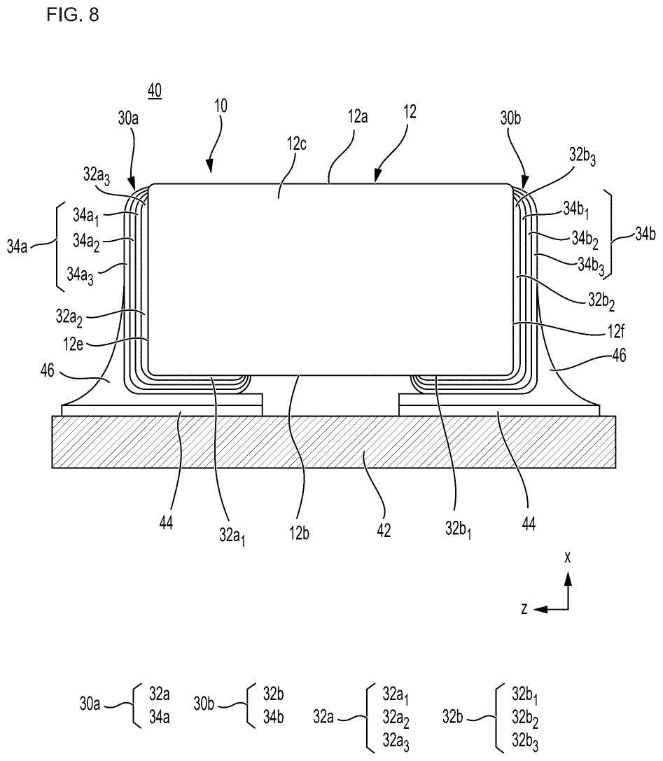

FIG. 1 is an external perspective view of an example of the two-terminal multilayer ceramic capacitor as the multilayer ceramic electronic component according to the present example embodiment of the present invention. FIG. 2 is a sectional view taken along a line II-II in FIG. 1. FIG. 3 is a sectional view adding a dummy electrode layer to FIG. 2. FIG. 4 is a partially enlarged view of FIG. 2. FIG. 5 is a sectional view taken along a line V-V in FIG. 1. FIG. 6 is a sectional view taken along a line VI-VI in FIG. 2. FIG. 7 is a sectional view taken along a line VII-VII in FIG. 2. FIG. 8 is a side view of an example of a mounting structure of a two-terminal multilayer ceramic capacitor according to an example embodiment of the present invention.

As illustrated in FIG. 1 and other drawings, a two-terminal multilayer ceramic capacitor 10 includes a rectangular parallelepiped multilayer body 12 and an outer electrode 30 located at both end portions of the multilayer body 12.

### (1) Multilayer Body

The multilayer body 12 includes a first main surface 12a and a second main surface 12b opposed to each other in a height direction x (lamination direction), a first side surface 12c and a second side surface 12d opposed to each other in a width direction y orthogonal to the height direction x, and a first end surface 12e and a second end surface 12f opposed to each other in a length direction z orthogonal to the height direction x and the width direction y. A corner portion and a ridge portion of the multilayer body 12 of the present example embodiment are rounded. The corner portion is a portion where three adjacent surfaces of the multilayer body 12 meet, and the ridge portion is a portion where two adjacent surfaces of the multilayer body 12 meet. Further, irregularities or the like may be formed on a portion or an entirety of the first main surface 12a and the second main surface 12b, the first side surface 12c and the second side surface 12d, and the first end surface 12e and the second end surface 12f.

The multilayer body 12 includes an outer layer portion 14a including multiple ceramic layers 14, and an inner layer portion 14b including the one or multiple ceramic layers 14 and multiple inner electrode layers 16 located thereon. The outer layer portion 14a is an aggregate of first multiple ceramic layers and second multiple ceramic layers. The first multiple ceramic layers are the multiple ceramic layers 14 positioned on a side of the first main surface 12a of the multilayer body 12 and are positioned between the first main surface 12a and the inner electrode layer 16 closest to the first main surface 12a. The second multiple ceramic layers are the multiple ceramic layers 14 positioned on a side of the second main surface 12b of the multilayer body 12 and are positioned between the second main surface 12b and the inner electrode layer 16 closest to the second main surface 12b. A region sandwiched by the outer layer portions 14a on both sides is the inner layer portion 14b. In the inner layer portion 14b, the ceramic layers 14 and the inner electrode layers 16 are alternately laminated in the height direction x.

An insulating layer may be provided on the first side surface 12c and the second side surface 12d of the multilayer body 12. When the insulating layer is provided, an interface between a first inner electrode layer 16a and the ceramic layer 14 and an interface between a second inner electrode layer 16b and the ceramic layer 14 each are covered with the insulating layer. This reduces or prevents moisture from entering from the outside of the two-terminal multilayer ceramic capacitor 10 to the inside thereof. The insulating layer may be positioned so as to be bonded to the first inner electrode layer 16a and the second inner electrode layer 16b. The insulating layer preferably has the same composition as the ceramic layer 14, but is not limited thereto.

Measurements of the multilayer body 12 are not particularly limited, but are appropriately designed in accordance with measurements of the two-terminal multilayer ceramic capacitor 10.

As a dielectric material forming the ceramic layer 14, a dielectric ceramic including BaTiO₃, CaTiO₃, SrTiO₃, CaZrO₃, or other components can be used, for example. When the ceramic material described above is included as the main component, corresponding to desired characteristics of the multilayer body 12, the ceramic material, to which a subcomponent with a content smaller than that of the main component is added, may be used. The subcomponent is a Mn compound, an Fe compound, a Cr compound, a Co compound, a Ni compound, or the like, for example.

The ceramic layer 14 may include multiple crystal grains including a perovskite compound having BaTiO₃ as the basic structure.

When a piezoelectric ceramic material is used for the ceramic layer 14, the multilayer ceramic electronic component functions as a piezoelectric component. Specific examples of the piezoelectric ceramic material include a PZT (lead zirconate titanate) based ceramic material.

When a semiconductor ceramic material is used for the ceramic layer 14, the multilayer ceramic electronic component functions as a thermistor. Specific examples of the semiconductor ceramic material include a spinel based ceramic material.

When a magnetic ceramic material is used for the ceramic layer 14, the multilayer ceramic electronic component functions as an inductor. When the multilayer ceramic electronic component functions as an inductor, the inner electrode layer 16 becomes a coiled conductor. Specific examples of the magnetic ceramic material include a ferrite ceramic material.

A thickness of the ceramic layer 14 after firing is preferably about 2 μm or less, for example. The number of ceramic layers 14 to be laminated is preferably 3 or more and 1000 or less, for example. The number of ceramic layers 14 is a total of the number of ceramic layers 14 in the inner layer portion 14b and the number of ceramic layers 14 in the outer layer portion 14a on the side of the first main surface 12a and in the outer layer portion 14a on the side of the second main surface 12b. The number of ceramic layers 14 in the outer layer portion 14a is preferably 2 or more and 100 or less.

As illustrated in FIG. 3, a first dummy electrode layer 29a and a second dummy electrode layer 29b may be provided in an L gap. The first dummy electrode layer 29a is provided on the same plane as the ceramic layer 14 on which the second inner electrode layer 16b is provided, being separated from the second inner electrode layer 16b, and the first dummy electrode layer 29a is exposed to the first end surface 12e. The first dummy electrode layer 29a faces an end portion of the first inner electrode layer 16a with the ceramic layer 14 interposed therebetween. On the other hand, the second dummy electrode layer 29b is provided on the same plane as the ceramic layer 14 on which the first inner electrode layer 16a is provided, being separated from the first inner electrode layer 16a, and the second dummy electrode layer 29b is exposed to the second end surface 12f. The second dummy electrode layer 29b faces an end portion of the second inner electrode layer 16b with the ceramic layer 14 interposed therebetween.

A step layer (not illustrated) may be provided in a place where each of the first dummy electrode layer 29a and the second dummy electrode layer 29b is provided in FIG. 3, as a replacement of each of the first dummy electrode layer 29a and the second dummy electrode layer 29b. Providing the step layer enables to reduce distortion in the height direction at an end portion of the two-terminal multilayer ceramic capacitor in the length direction. Each of the first inner electrode layer 16a and the second inner electrode layer 16b may cover a portion of the step layer, or the step layer may cover a portion each of the first inner electrode layer 16a and the second inner electrode layer 16b. The step layer may have a thickness comparable with those of the first inner electrode layer 16a and the second inner electrode layer 16b. The step layer preferably has the same composition as the ceramic layer 14, but is not limited thereto.

The multilayer body 12 includes, as the multiple inner electrode layers 16, the multiple first inner electrode layers 16a extended to the first end surface 12e and the multiple second inner electrode layers 16b extended to the second end surface 12f. The multiple first inner electrode layers 16a and the multiple second inner electrode layers 16b are embedded in the inner layer portion 14b so as to be alternately provided with the ceramic layer 14 interposed therebetween at equal intervals along the height direction x of the multilayer body 12. Surfaces of the multiple first inner electrode layers 16a and surfaces of the multiple second inner electrode layers 16b are substantially parallel to the first main surface 12a and the second main surface 12b, and have a substantially rectangular shape, for example, in plan view.

As illustrated in FIG. 2 and FIG. 6, the first inner electrode layer 16a is provided on the multiple ceramic layers 14 and is positioned inside the multilayer body 12. The first inner electrode layer 16a includes a first facing electrode portion 26a facing the second inner electrode layer 16b, and a first extended electrode portion 28a positioned on one end side of the first inner electrode layer 16a and extended from the first facing electrode portion 26a to the first end surface 12e of the multilayer body 12. The first extended electrode portion 28a includes an end portion extended to a surface of the first end surface 12e, and is exposed from the multilayer body 12. That is, the first extended electrode portion 28a is not exposed at any of the first main surface 12a, the second main surface 12b, the first side surface 12c, the second side surface 12d, and the second end surface 12f. The end portion of the first facing electrode portion 26a is positioned to recede from a surface of the second end surface 12f in the length direction z.

A shape of the first facing electrode portion 26a of the first inner electrode layer 16a is not particularly limited, but is preferably a rectangular shape in plan view. A corner portion may be rounded in plan view, or the corner portion may be obliquely positioned in plan view (tapered shape). Further, the shape may be of a tapered shape in plan view in which the shape is inclined toward either side.

A shape of the first extended electrode portion 28a of the first inner electrode layer 16a is not particularly limited thereto, but is preferably a rectangular shape in plan view. A corner portion may be rounded in plan view, or the corner portion may be obliquely positioned in plan view (tapered shape). Further, the shape may be of a tapered shape in plan view in which the shape is inclined toward either side.

The first extended electrode portion 28a of the first inner electrode layer 16a may be curved toward a center portion of the first end surface 12e of the multilayer body 12 in the height direction x.

A width of the first facing electrode portion 26a of the first inner electrode layer 16a in the width direction y and a width of the first extended electrode portion 28a of the first inner electrode layer 16a in the width direction y may be the same, or either one of the widths in the width direction y may be narrower.

As illustrated in FIG. 2 and FIG. 7, the second inner electrode layer 16b is provided on the multiple ceramic layers 14 and is positioned inside the multilayer body 12. The second inner electrode layer 16b includes a second facing electrode portion 26b facing the first inner electrode layer 16a, and a second extended electrode portion 28b positioned on one end side of the second inner electrode layer 16b and extended from the second facing electrode portion 26b to the second end surface 12f of the multilayer body 12. The second extended electrode portion 28b includes an end portion extended to the surface of the second end surface 12f, and is exposed from the multilayer body 12. That is, the second extended electrode portion 28b is not exposed at any of the first main surface 12a, the second main surface 12b, the first side surface 12c, the second side surface 12d, and the first end surface 12e. The end portion of the second facing electrode portion 26b recedes from the surface of the first end surface 12e in the length direction z.

A shape of the second facing electrode portion 26b of the second inner electrode layer 16b is not particularly limited thereto, but is preferably a rectangular or substantially rectangular shape in plan view. A corner portion may be rounded in plan view, or the corner portion may be obliquely positioned in plan view (tapered shape). Further, the shape may be of a tapered shape in plan view in which the shape is inclined toward either side.

A shape of the second extended electrode portion 28b of the second inner electrode layer 16b is not particularly limited thereto, but is preferably a rectangular or substantially rectangular shape in plan view. A corner portion may be rounded in plan view, or the corner portion may be obliquely positioned in plan view (tapered shape). Further, the shape may be of a tapered shape in plan view in which the shape is inclined toward either side.

The second extended electrode portion 28b of the second inner electrode layer 16b may be curved toward a center portion of the second end surface 12f of the multilayer body 12 in the height direction x.

A width of the second facing electrode portion 26b of the second inner electrode layer 16b in the width direction y and a width of the second extended electrode portion 28b of the second inner electrode layer 16b in the width direction y may be the same, or either one of the widths in the width direction y may be narrower.

A distance between the first extended electrode portion 28a of the first inner electrode layer 16a closest to the first main surface 12a and the second extended electrode portion 28b of the second inner electrode layer 16b closest to the second main surface 12b may be shorter than a distance between the first facing electrode portion 26a closest to the first main surface 12a and the second facing electrode portion 26b closest to the second main surface 12b.

The first inner electrode layer 16a and the second inner electrode layer 16b may be made of any appropriate conductive material, for example, metals such as Ni, Cu, Ag, Pd, and Au, or an alloy including at least one of these metals, such as an Ag—Pd alloy, but the material is not limited thereto.

A thickness of the inner electrode layer 16, that is, a thickness of each of the first inner electrode layer 16a and the second inner electrode layer 16b is preferably about 0.3 μm or more and about 0.8 μm or less, for example. The thickness of each of the first inner electrode layer 16a and the second inner electrode layer 16b is preferably uniform, but a thickness at an edge portion in the width direction y may be larger than a thickness at a center portion in the width direction y.

The total number of the first inner electrode layers 16a and the second inner electrode layers 16b is preferably 3 or more and 1000 or less.

In the multilayer body 12, the first facing electrode portion 26a of the first inner electrode layer 16a and the second facing electrode portion 26b of the second inner electrode layer 16b face each other with the ceramic layer 14 interposed therebetween, thus generating electrostatic capacitance. This makes characteristics of a capacitor be exhibited.

In order to increase capacitance of the capacitor, areas of the first inner electrode layer 16a and the second inner electrode layer 16b need be enlarged. Thus, a coverage of an LW surface of the first inner electrode layer 16a and the second inner electrode layer 16b is preferably about 90% or more, for example. The coverage of the LW surface is defined as a ratio of an area where the first inner electrode layer 16a or the second inner electrode layer 16b is provided (area obtained by subtracting an area of a space, where the first inner electrode layer 16a or the second inner electrode layer 16b is not provided, from total area) to the total area of a layer where the first inner electrode layer 16a or the second inner electrode layer 16b is provided when the LW surface is viewed from the height direction x of the multilayer body 12. Capacitance of a capacitor increases as the coverage of the LW surface increases. However, even when the number of spaces is large and the capacitance of the capacitor is low, interlayer separation is unlikely to occur since the ceramic layers 14 are bonded to each other through the spaces and the bonding strength between layers increases.

### (2) Outer Electrode

As illustrated in FIG. 1 to FIG. 3, the outer electrode 30 is provided on each of a side of the first end surface 12e and a side of the second end surface 12f of the multilayer body 12.

The outer electrode 30 includes a first outer electrode 30a and a second outer electrode 30b.

The first outer electrode 30a is coupled to the first inner electrode layer 16a and is provided on surfaces of a portion the second main surface 12b and the first end surface 12e. In this case, the first outer electrode 30a is electrically coupled to the first extended electrode portion 28a of the first inner electrode layer 16a.

The second outer electrode 30b is coupled to the second inner electrode layer 16b and is provided on surfaces of a portion the second main surface 12b and the second end surface 12f. In this case, the second outer electrode 30b is electrically coupled to the second extended electrode portion 28b of the second inner electrode layer 16b.

In the multilayer body 12, the first inner electrode layer 16a and the second inner electrode layer 16b face each other with the ceramic layer 14 interposed therebetween, thus generating electrostatic capacitance. As a result, electrostatic capacitance can be obtained between the first outer electrode 30a to which the first inner electrode layer 16a is coupled and the second outer electrode 30b to which the second inner electrode layer 16b is coupled. This makes characteristics of a capacitor be exhibited.

A thickness of each of the first outer electrode 30a and the second outer electrode 30b is preferably about 6.0 μm or more and about 20.0 μm or less, for example.

The outer electrode 30 includes a thin film layer 32 and a plating layer 34 provided on the thin film layer 32. The thin film layer 32 includes a first thin film layer 32a and a second thin film layer 32b. The plating layer 34 includes a first plating layer 34a and a second plating layer 34b.

Specifically, the first outer electrode 30a includes the first thin film layer 32a and the first plating layer 34a positioned to cover the first thin film layer 32a. The second outer electrode 30b includes the second thin film layer 32b and the second plating layer 34b positioned to cover the second thin film layer 32b.

### (2-1) Thin Film Layer

### (2-1-1) First Thin Film Layer

The first thin film layer 32a includes a first main surface thin film layer 32a₁ on a portion the second main surface 12b, a first end surface thin film layer 32a₂ on the first end surface 12e, and a first continuous thin film layer 32a₃ continuously extending from the first end surface thin film layer 32a₂ toward the side of the first main surface 12a in the height direction x.

The first main surface thin film layer 32a₁ may extend around from the second main surface 12b onto the first end surface 12e. That is, the first main surface thin film layer 32a₁ may extend from the second main surface 12b toward a side of the first end surface thin film layer 32a₂ on the first end surface 12e. The first main surface thin film layer 32a₁ may be continuous or discontinuous with the first end surface thin film layer 32a₂.

The first main surface thin film layer 32a₁ is formed by depositing metal particles, and is a layer whose thickness from the surface of the multilayer body 12 is about 1 μm or less, for example.

The first end surface thin film layer 32a₂ is provided on at least a portion the first end surface 12e. When the first end surface thin film layer 32a₂ is continuous with the first main surface thin film layer 32a₁, the first end surface thin film layer 32a₂ may at least partially be covered with the first main surface thin film layer 32a₁, or the first end surface thin film layer 32a₂ may at least partially cover the first main surface thin film layer 32a₁.

The first end surface thin film layer 32a₂ is formed by depositing metal particles, and is a layer whose thickness t1 (see FIG. 4) from the surface of the multilayer body 12 is about 1 μm or less, for example.

The first continuous thin film layer 32a₃ is provided on at least a portion the first end surface 12e, and extends continuously with the first end surface thin film layer 32a₂ toward the side of the first main surface 12a opposite to the second main surface 12b in the height direction x. Thus, the first continuous thin film layer 32a₃ is provided on the side of the first main surface 12a, and the first main surface thin film layer 32a₁ is provided on the side of the second main surface 12b, sandwiching the first end surface thin film layer 32a₂. That is, the first main surface thin film layer 32a₁ and the first continuous thin film layer 32a₃ are provided on sides opposite to each other in the height direction x sandwiching the first end surface thin film layer 32a2.

In the present example embodiment, a bonding strength between the first continuous thin film layer 32a₃ and the ceramic layer 14 of the multilayer body 12 is smaller than a bonding strength between the first end surface thin film layer 32a₂ and the ceramic layer 14 of the multilayer body 12. In the present example embodiment, a thickness t3 of the first continuous thin film layer 32a₃ in the length direction z is smaller than the thickness t1 of the first end surface thin film layer 32a₂ in the length direction z, so that the bonding strength between the first continuous thin film layer 32a₃ and the ceramic layer 14 is smaller than the bonding strength between the first end surface thin film layer 32a₂ and the ceramic layer 14. Thus, when stress such as thermal stress and/or mechanical stress is applied to the two-terminal multilayer ceramic capacitor 10, the occurrence of a crack in the two-terminal multilayer ceramic capacitor 10 can be reduced or prevented.

The thickness of the first continuous thin film layer 32a₃ is preferably about 20 nm or more and about 100 nm or less, for example. This can weaken the bonding strength between the first continuous thin film layer 32a₃ and the ceramic layer 14.

Specifically, when stress such as thermal stress and/or mechanical stress is applied to the two-terminal multilayer ceramic capacitor 10, the first outer electrode 30a is separated from the multilayer body 12 at a bonding portion of the first continuous thin film layer 32a₃ and the ceramic layer 14 where the bonding strength is smaller than that of the first end surface thin film layer 32a₂ and the ceramic layer 14. That is, the stress applied to the two-terminal multilayer ceramic capacitor 10 is released with the separation starting from the bonding portion. Thus, the occurrence of a crack extending toward the inside of the two-terminal multilayer ceramic capacitor 10, which is caused by the extension of a crack in the ceramic layer 14 between the first inner electrode layer 16a and the first outer electrode 30a, for example, can be reduced or prevented, while increasing the bonding strength between the first end surface thin film layer 32a₂ and the ceramic layer 14.

The thickness of the first continuous thin film layer 32a₃ is preferably smaller than that of the first main surface thin film layer 32a₁. In other words, the thickness of the first main surface thin film layer 32a₁ is preferably larger than that of the first continuous thin film layer 32a₃. This increases the bonding strength between the first main surface thin film layer 32a₁ and the ceramic layer 14, and can reduce the separation of the first outer electrode 30a from the multilayer body 12 on the side of the second main surface 12b.

In the present example embodiment, the first continuous thin film layer 32a₃ is continuous with the first end surface thin film layer 32a₂ toward a side opposite to the first main surface thin film layer 32a₁. This makes it possible to reduce the occurrence of a crack toward the inside of the two-terminal multilayer ceramic capacitor 10 by allowing the first continuous thin film layer 32a₃ to be separated, while increasing the bonding strength between the first main surface thin film layer 32a₁ and the ceramic layer 14, and between the first end surface thin film layer 32a₂ and the ceramic layer 14.

When the first main surface thin film layer 32a₁ extends around from the second main surface 12b onto the first end surface 12e, a bonding region between the first main surface thin film layer 32a₁ and the ceramic layer 14 increases. This makes it possible to reduce the separation of the first main surface thin film layer 32a₁ from the multilayer body 12.

Further, when the first main surface thin film layer 32a₁ extends around from the second main surface 12b onto the first end surface 12e and is continuous with the first end surface thin film layer 32a₂, the bonding strength between the first main surface thin film layer 32a₁ and the first end surface thin film layer 32a₂ increases. This makes it possible to reduce the separation of the first main surface thin film layer 32a₁ and the first end surface thin film layer 32a₂ from the multilayer body 12.

The first continuous thin film layer 32a₃ will further be described.

The first continuous thin film layer 32a₃ is preferably not coupled to the first inner electrode layer 16a. In a case of the present example embodiment, as illustrated in FIG. 4, the first continuous thin film layer 32a₃ is closer to the first main surface 12a than the outermost surface of the first inner electrode layer 16a closest to the first main surface 12a among the multiple first inner electrode layers 16a. That is, the first continuous thin film layer 32a₃ extends toward a tip end in a portion closer to the first main surface 12a than the outermost surface of the first inner electrode layer 16a closest to the first main surface 12a. Even when the first continuous thin film layer 32a₃ is separated from the first end surface 12e due to stress such as thermal stress and/or mechanical stress, entry of moisture from the outside of the two-terminal multilayer ceramic capacitor 10 to the inside of the multilayer body 12 along the first inner electrode layer 16a can be reduced or prevented since the first inner electrode layer 16a is not present in the separated portion.

In the first continuous thin film layer 32a₃, the thickness t3 in the length direction z preferably becomes smaller toward the first main surface 12a (surface opposite to second main surface 12b). That is, the thickness t3 of the first continuous thin film layer 32a₃ becomes smaller from the first end surface thin film layer 32a₂ toward a side opposite to the second main surface 12b where the first main surface thin film layer 32a₁ is provided. Since the thickness t3 of the first continuous thin film layer 32a₃ in the length direction z becomes smaller toward the first main surface 12a, the bonding strength between the first continuous thin film layer 32a₃ and the ceramic layer 14 can be weakened toward the first main surface 12a. The first continuous thin film layer 32a₃ in a tip portion having the small thickness is more likely to be separated since the bonding strength to the ceramic layer 14 becomes smaller. Thus, the first continuous thin film layer 32a₃ is easily separated with the tip portion, where the bonding strength is small, being a starting point. This makes it possible to release stress on the two-terminal multilayer ceramic capacitor 10 by separating the first continuous thin film layer 32a₃ from the ceramic layer 14 on the side of the first main surface 12a of the first end surface 12e, while increasing the bonding strength between the ceramic layer 14 and the first main surface thin film layer 32a₁ and the first end surface thin film layer 32a₂ on the second main surface 12b and the first end surface 12e. Thus, the occurrence of a crack toward the inside of the two-terminal multilayer ceramic capacitor 10 can be reduced or prevented.

A length t2 of the first continuous thin film layer 32a₃ in the height direction x is preferably about twice or more and about five times or less the thickness t1 of the first end surface thin film layer 32a₂ in the length direction z. Preferably, the first continuous thin film layer 32a₃ does not extend around the first main surface 12a.

When the length t2 of the first continuous thin film layer 32a₃ in the height direction x is too short, the starting point of separation of the first continuous thin film layer 32a₃ from the multilayer body 12 due to stress becomes close to the outermost surface of the first inner electrode layer 16a on the side of the first main surface 12a among the multiple first inner electrode layers 16a. In this case, since the first inner electrode layer 16a is exposed, moisture enters the inside of the multilayer body 12 from the outside of the two-terminal multilayer ceramic capacitor 10. Thus, insulation property of the two-terminal multilayer ceramic capacitor 10 cannot be ensured.

On the other hand, when the length t2 of the first continuous thin film layer 32a₃ in the height direction x is too long, the first continuous thin film layer 32a₃ may extend around onto the first main surface 12a. In this case, the starting point of the stress due to separation, applied to the multilayer body 12 by the first continuous thin film layer 32a₃, becomes closer to a center portion of the multilayer body 12 in the length direction z. That is, a position of the stress acting in the height direction x at the starting point is positioned at the center portion of the multilayer body 12 in the length direction z. As a result, a crack generated by the stress reaches the first inner electrode layer 16a (and/or second inner electrode layer 16b) from the side of the first main surface 12a. Thus, moisture enters the inside of the multilayer body 12 from the outside of the two-terminal multilayer ceramic capacitor 10, and the insulation property of the two-terminal multilayer ceramic capacitor 10 cannot be ensured.

The first main surface thin film layer 32a₁ preferably includes at least either one of Cr and Ti. When the first main surface thin film layer 32a₁ includes at least either one of Cr and Ti, the bonding strength between the ceramic layer 14 of the multilayer body 12 and the first main surface thin film layer 32a₁ increases, and the separation of the first outer electrode 30a can be reduced or prevented.

The first end surface thin film layer 32a₂ preferably includes at least either one of Ni or Cu. When the first end surface thin film layer 32a₂ includes at least either one of Ni and Cu, the bonding strength between the first inner electrode layer 16a and the first end surface thin film layer 32a₂ increases, and thus the resistivity in the first outer electrode 30a and the first inner electrode layer 16a can be reduced or prevented.

The first continuous thin film layer 32a₃ preferably includes at least either one of Ni and Cu. Since the first continuous thin film layer 32a₃ includes the same components as those of the first end surface thin film layer 32a₂, the first continuous thin film layer 32a₂ and the first end surface thin film layer 32a₃ may continuously and easily be formed. As a result, when stress is applied to the two-terminal multilayer ceramic capacitor 10, the first continuous thin film layer 32a₃ is separated, and at the same time, the stress on the first end surface thin film layer 32a₂ continuous with the first continuous thin film layer 32a₃ is reduced, and the bonding strength between the first end surface thin film layer 32a₂ and the ceramic layer 14 is increased. This can reduce or prevent the occurrence of a crack toward the inside of the two-terminal multilayer ceramic capacitor 10.

The main component of the first end surface thin film layer 32a₂ may be different from the main component of the first continuous thin film layer 32a₃. In order to form the plating layer 34 on the first main surface thin film layer 32a₁, the first end surface thin film layer 32a₂, and the first continuous thin film layer 32a₃, each of the first main surface thin film layer 32a₁, the first end surface thin film layer 32a₂, and the first continuous thin film layer 32a₃ preferably includes a metal with low specific resistance as the main component.

The first main surface thin film layer 32a₁, the first end surface thin film layer 32a₂, and the first continuous thin film layer 32a₃ can be formed by a sputtering method, a vapor deposition method, or the like.

The thickness of each of the first main surface thin film layer 32a₁, the first end surface thin film layer 32a₂, and the first continuous thin film layer 32a₃ is measured as follows. The two-terminal multilayer ceramic capacitor 10 is polished to about ⅓ or about ½ in the width direction y, for example. Thereafter, the thickness of each of the thin film layers 32a₁ to 32a₃ is measured with an actual observation image under a scanning electron microscope. Instead of the polishing, a section of each of the thin film layers 32a₁ to 32a₃ can be exposed by scraping with FIB.

In addition, there is a method of measuring the thickness using a fluorescent X-ray apparatus. Specifically, a metal type of each of the first main surface thin film layer 32a₁, the first end surface thin film layer 32a₂, and the first continuous thin film layer 32a₃ is measured by a calibration curve method using the fluorescent X-ray apparatus. Based on the concentration of a predetermined element (concentration of an element in each of the thin film layers 32a₁ to 32a₃), the measurement result is converted to the thickness of each of the thin film layers 32a₁ to 32a₃.

### (2-1-2) Second Thin Film Layer

The second thin film layer 32b includes a second main surface thin film layer 32b₁ on a portion the second main surface 12b, a second end surface thin film layer 32b₂ on the second end surface 12f, and a second continuous thin film layer 32b₃ continuously extending from the second end surface thin film layer 32b₂ toward the side of the first main surface 12a in the height direction x. The second main surface thin film layer 32b₁, the second end surface thin film layer 32b₂, and the second continuous thin film layer 32b₃ are symmetrical to the first main surface thin film layer 32a₁, the first end surface thin film layer 32a₂, and the first continuous thin film layer 32a₃, respectively, with respect to a center of the multilayer body 12 in the length direction z.

The second main surface thin film layer 32b₁ may extend around from the second main surface 12b onto the second end surface 12f. That is, the second main surface thin film layer 32b₁ may extend from the second main surface 12b toward a side of the second end surface thin film layer 32b₂ on the second end surface 12f. The second main surface thin film layer 32b₁ may be continuous or discontinuous with the second end surface thin film layer 32b₂.

The second main surface thin film layer 32b₁ is formed by depositing metal particles, and is a layer whose thickness from the surface of the multilayer body 12 is about 1 μm or less, for example.

The second end surface thin film layer 32b₂ is provided on at least a portion the second end surface 12f. When the second end surface thin film layer 32b₂ is continuous with the second main surface thin film layer 32b₁, the second end surface thin film layer 32b₂ may at least partially be covered with the second main surface thin film layer 32b₁, or the second end surface thin film layer 32b₂ may at least partially cover the second main surface thin film layer 32b₁.

The second end surface thin film layer 32b₂ is formed by depositing metal particles, and is a layer whose thickness from the surface of the multilayer body 12 is about 1 μm or less, for example.

The second continuous thin film layer 32b₃ is provided on at least a portion the second end surface 12f, and extends continuously with the second end surface thin film layer 32b₂ toward the side of the first main surface 12a opposite to the second main surface 12b in the height direction x. Thus, the second continuous thin film layer 32b₃ is provided on the side of the first main surface 12a, and the second main surface thin film layer 32b₁ is provided on the side of the second main surface 12b, sandwiching the second end surface thin film layer 32b₂. That is, the second main surface thin film layer 32b₁ and the second continuous thin film layer 32b₃ are on sides opposite to each other in the height direction x sandwiching the second end surface thin film layer 32b₂.

In the present example embodiment, a bonding strength between the second continuous thin film layer 32b₃ and the ceramic layer 14 of the multilayer body 12 is smaller than a bonding strength between the second end surface thin film layer 32b₂ and the ceramic layer 14 of the multilayer body 12. In the present example embodiment, a thickness of the second continuous thin film layer 32b₃ in the length direction z is smaller than a thickness of the second end surface thin film layer 32b₂ in the length direction z, so that the bonding strength between the second continuous thin film layer 32b₃ and the ceramic layer 14 is smaller than the bonding strength between the second end surface thin film layer 32b₂ and the ceramic layer 14. Thus, when stress such as thermal stress and/or mechanical stress is applied to the two-terminal multilayer ceramic capacitor 10, the occurrence of a crack in the two-terminal multilayer ceramic capacitor 10 can be reduced or prevented.

The thickness of the second continuous thin film layer 32b₃ is preferably about 20 nm or more and about 100 nm or less, for example. This can weaken the bonding strength between the second continuous thin film layer 32b₃ and the ceramic layer 14.

Specifically, when stress such as thermal stress and/or mechanical stress is applied to the two-terminal multilayer ceramic capacitor 10, the second outer electrode 30b is separated from the multilayer body 12 at a bonding portion of the second continuous thin film layer 32b₃ and the ceramic layer 14 where the bonding strength is smaller than that of the second end surface thin film layer 32b₂ and the ceramic layer 14. That is, the stress applied to the two-terminal multilayer ceramic capacitor 10 is released with the separation starting from the bonding portion. Thus, the occurrence of a crack extending toward the inside of the two-terminal multilayer ceramic capacitor 10, which is caused by the extension of a crack in the ceramic layer 14 between the second inner electrode layer 16b and the second outer electrode 30b, for example, can be reduced, while increasing the bonding strength between the second end surface thin film layer 32b₂ and the ceramic layer 14.

The thickness of the second continuous thin film layer 32b₃ is preferably smaller than that of the second main surface thin film layer 32b₁. In other words, the thickness of the second main surface thin film layer 32b₁ is preferably larger than that of the second continuous thin film layer 32b₃. This increases the bonding strength between the second main surface thin film layer 32b₁ and the ceramic layer 14, and can reduce the separation of the second outer electrode 30b from the multilayer body 12 on the side of the second main surface 12b.

In the present example embodiment, the second continuous thin film layer 32b₃ is continuous with the second end surface thin film layer 32b₂ toward a side opposite to the second main surface thin film layer 32b₁. This makes it possible to reduce the occurrence of a crack toward the inside of the two-terminal multilayer ceramic capacitor 10 by allowing the second continuous thin film layer 32b₃ to be separated, while increasing the bonding strength between the second main surface thin film layer 32b₁ and the ceramic layer 14, and between the second end surface thin film layer 32b₂ and the ceramic layer 14.

When the second main surface thin film layer 32b₁ extends around from the second main surface 12b onto the second end surface 12f, a bonding region between the second main surface thin film layer 32b₁ and the ceramic layer 14 increases. This makes it possible to reduce the separation of the second main surface thin film layer 32b₁ from the multilayer body 12.

Further, when the second main surface thin film layer 32b₁ extends around from the second main surface 12b onto the second end surface 12f and is continuous with the second end surface thin film layer 32b₂, the bonding strength between the second main surface thin film layer 32b₁ and the second end surface thin film layer 32b₂ increases. This makes it possible to reduce the separation of the second main surface thin film layer 32b₁ and the second end surface thin film layer 32b₂ from the multilayer body 12.

The second continuous thin film layer 32b₃ will further be described.

The second continuous thin film layer 32b₃ is preferably not coupled to the second inner electrode layer 16b. In a case of the present example embodiment, the second continuous thin film layer 32b₃ is closer to the first main surface 12a than the outermost surface of the second inner electrode layer 16b closest to the first main surface 12a among the multiple second inner electrode layers 16b. That is, the second continuous thin film layer 32b₃ extends toward a tip end in a portion closer to the first main surface 12a than the outermost surface of the second inner electrode layer 16b closest to the first main surface 12a. Even when the second continuous thin film layer 32b₃ is separated from the second end surface 12f due to stress such as thermal stress and/or mechanical stress, entry of moisture from the outside of the two-terminal multilayer ceramic capacitor 10 to the inside of the multilayer body 12 along the second inner electrode layer 16b can be prevented since the second inner electrode layer 16b is not present in the separated portion.

In the second continuous thin film layer 32b₃, the thickness in the length direction z preferably becomes smaller toward the first main surface 12a (surface opposite to second main surface 12b). That is, the thickness of the second continuous thin film layer 32b₃ becomes smaller from the second end surface thin film layer 32b₂ toward the side opposite to the second main surface 12b where the second main surface thin film layer 32b₁ is located. Since the thickness of the second continuous thin film layer 32b₃ in the length direction z becomes smaller toward the first main surface 12a, the bonding strength between the second continuous thin film layer 32b₃ and the ceramic layer 14 can be weakened toward the first main surface 12a. The second continuous thin film layer 32b₃ in a tip portion having the small thickness is more likely to be separated since the bonding strength to the ceramic layer 14 becomes smaller. Thus, the second continuous thin film layer 32b₃ is easily separated with the tip portion, where the bonding strength is small, being a starting point. This makes it possible to release stress on the two-terminal multilayer ceramic capacitor 10 by separating the second continuous thin film layer 32b₃ from the ceramic layer 14 on the side of the first main surface 12a of the second end surface 12f, while increasing the bonding strength between the ceramic layer 14 and the second main surface thin film layer 32b₁ and the second end surface thin film layer 32b₂ on the second main surface 12b and the second end surface 12f. Thus, the occurrence of a crack toward the inside of the two-terminal multilayer ceramic capacitor 10 can be reduced or prevented. Thus, even when the measurement of the two-terminal multilayer ceramic capacitor 10 in the height direction is very small, the occurrence of a crack is easily reduced or prevented.

A length of the second continuous thin film layer 32b₃ in the height direction x is preferably about twice or more and about five times or less the thickness of the second end surface thin film layer 32b₂ in the length direction z. Preferably, the second continuous thin film layer 32b₃ does not extend around the first main surface 12a.

When the length of the second continuous thin film layer 32b₃ in the height direction x is too short, the starting point of separation of the second continuous thin film layer 32b₃ from the multilayer body 12 due to stress becomes close to the outermost surface of the second inner electrode layer 16b on the side of the first main surface 12a among the multiple second inner electrode layers 16b. In this case, since the second inner electrode layer 16b is exposed, moisture enters the inside of the multilayer body 12 from the outside of the two-terminal multilayer ceramic capacitor 10. Thus, insulation property of the two-terminal multilayer ceramic capacitor 10 cannot be ensured.

On the other hand, when the length of the second continuous thin film layer 32b₃ in the height direction x is too long, the second continuous thin film layer 32b₃ may extend around onto the first main surface 12a. In this case, the starting point of the stress due to separation, applied to the multilayer body 12 by the second continuous thin film layer 32b₃, becomes closer to the center portion of the multilayer body 12 in the length direction z. That is, a position of the stress acting in the height direction x at the starting point is positioned at the center portion of the multilayer body 12 in the length direction z. As a result, a crack generated by the stress reaches the second inner electrode layer 16b (and/or first inner electrode layer 16a) from the side of the first main surface 12a. Thus, moisture enters the inside of the multilayer body 12 from the outside of the two-terminal multilayer ceramic capacitor 10, and the insulation property of the two-terminal multilayer ceramic capacitor 10 cannot be ensured.

The second main surface thin film layer 32b₁ preferably includes at least either one of Cr or Ti. When the second main surface thin film layer 32b₁ includes at least either one of Cr and Ti, the bonding strength between the ceramic layer 14 of the multilayer body 12 and the second main surface thin film layer 32b₁ increases, and the separation of the second outer electrode 30b can be reduced or prevented.

The second end surface thin film layer 32b₂ preferably includes at least either one of Ni or Cu. When the second end surface thin film layer 32b₂ includes at least either one of Ni and Cu, the bonding strength between the second inner electrode layer 16b and the second end surface thin film layer 32b₂ increases, and thus the resistivity in the second outer electrode 30b and the second inner electrode layer 16b can be reduced or prevented.

The second continuous thin film layer 32b₃ preferably includes at least either one of Ni and Cu. Since the second continuous thin film layer 32b₃ includes the same components as those of the second end surface thin film layer 32b₂, the second continuous thin film layer 32b₂ and the second end surface thin film layer 32b₃ may continuously and easily be formed. As a result, when stress is applied to the two-terminal multilayer ceramic capacitor 10, the second continuous thin film layer 32b₃ is separated, and at the same time, the stress on the second end surface thin film layer 32b₂ continuous with the second continuous thin film layer 32b₃ is reduced, and the bonding strength between the second end surface thin film layer 32b₂ and the ceramic layer 14 is increased. This can reduce or prevent the occurrence of a crack that is created toward the inside of the two-terminal multilayer ceramic capacitor 10.

The main component of the second end surface thin film layer 32b₂ may be different from the main component of the second continuous thin film layer 32b₃. In order to form the plating layer 34 on the second main surface thin film layer 32b₁, the second end surface thin film layer 32b₂, and the second continuous thin film layer 32b₃, each of the second main surface thin film layer 32b₁, the second end surface thin film layer 32b₂, and the second continuous thin film layer 32b₃ preferably includes a metal with low specific resistance as the main component.

The second main surface thin film layer 32b₁, the second end surface thin film layer 32b₂, and the second continuous thin film layer 32b₃ can be formed by a sputtering method, a vapor deposition method, or the like.

The thickness of each of the second main surface thin film layer 32b₁, the second end surface thin film layer 32b₂, and the second continuous thin film layer 32b₃ can be measured by the same method as that for each of the first main surface thin film layer 32a₁, the first end surface thin film layer 32a₂, and the first continuous thin film layer 32a₃.

### (2-2) Plating Layer

### (2-2-1) First Plating Layer

The first plating layer 34a is provided on the first main surface thin film layer 32a₁, the first end surface thin film layer 32a₂, and the first continuous thin film layer 32a₃ to cover these layers. The first plating layer 34a includes, for example, at least one selected from Cu, Ni, Sn, Ag, Pd, Ag—Pd alloys, Au, and the like.

The first plating layer 34a is not limited to the above, and may be formed of multiple layers. The first plating layer 34a includes a first lower plating layer 34a₁, a first intermediate plating layer 34a₂ on the first lower plating layer 34a₁, and a first upper plating layer 34a₃ on the first intermediate plating layer 34a₂. The first lower plating layer 34a₁ may be a Cu plating layer, the first intermediate plating layer 34a₂ may be a Ni plating layer, and the first upper plating layer 34a₃ may be a Sn plating layer.

The first intermediate plating layer 34a₂, which is the Ni plating layer, is used to prevent the first main surface thin film layer 32a₁, the first end surface thin film layer 32a₂, and the first continuous thin film layer 32a₃ from being eroded by solder when the two-terminal multilayer ceramic capacitor 10 is mounted. The first upper plating layer 34a₃, which is a Sn plating layer, is used to facilitate mounting by increasing wettability of solder when the two-terminal multilayer ceramic capacitor 10 is mounted.

The first lower plating layer 34a₁ may be a Sn plating layer, the first intermediate plating layer 34a₂ may be a Ni plating layer, and the first upper plating layer 34a₃ may be a Sn plating layer.

The first plating layer 34a may be including two plating layers. That is, the first plating layer 34a includes a lower plating layer covering the first main surface thin film layer 32a₁, the first end surface thin film layer 32a₂, and the first continuous thin film layer 32a₃, and an upper plating layer on the lower plating layer. The lower plating layer may be a Ni plating layer, and the upper plating layer may be a Sn plating layer.

A thickness of each of the plating layers constituting the first plating layer 34a is preferably, for example, about 2 μm or more and about 7 μm or less. For example, the thickness of each of the first lower plating layer 34a₁, the first intermediate plating layer 34a₂, and the first upper plating layer 34a₃ is preferably about 2 μm or more and about 7 μm or less, for example.

### (2-2-2) Second Plating Layer

The second plating layer 34b is provided on the second main surface thin film layer 32b₁, the second end surface thin film layer 32b₂, and the second continuous thin film layer 32b₃ to cover these layers. The second plating layer 34b includes, for example, at least one selected from Cu, Ni, Sn, Ag, Pd, Ag—Pd alloys, Au, and the like.

The second plating layer 34b is not limited to the above, and may be formed of multiple layers. The second plating layer 34b includes a second lower plating layer 34b₁, a second intermediate plating layer 34b₂ on the second lower plating layer 34b₁, and a second upper plating layer 34b₃ on the second intermediate plating layer 34b₂. The second lower plating layer 34b₁ may be a Cu plating layer, the second intermediate plating layer 34b₂ may be a Ni plating layer, and the second upper plating layer 34b₃ may be a Sn plating layer.

The second intermediate plating layer 34b₂, which is the Ni plating layer, is used to prevent the second main surface thin film layer 32b₁, the second end surface thin film layer 32b₂, and the second continuous thin film layer 32b₃ from being eroded by solder when the two-terminal multilayer ceramic capacitor 10 is mounted. The second upper plating layer 34b₃, which is a Sn plating layer, is used to facilitate mounting by increasing wettability of solder when the two-terminal multilayer ceramic capacitor 10 is mounted.

The second lower plating layer 34b₁ may be a Sn plating layer, the second intermediate plating layer 34b₂ may be a Ni plating layer, and the second upper plating layer 34b₃ may be a Sn plating layer.

The second plating layer 34b may be including two plating layers. That is, the second plating layer 34b includes a lower plating layer covering the second main surface thin film layer 32b₁, the second end surface thin film layer 32b₂, and the second continuous thin film layer 32b₃, and an upper plating layer on the lower plating layer. The lower plating layer may be a Ni plating layer, and the upper plating layer may be a Sn plating layer.

A thickness of each of the plating layers constituting the second plating layer 34b is preferably about 2 μm or more and about 7 μm or less, for example. For example, the thickness of each of the second lower plating layer 34b₁, the second intermediate plating layer 34b₂, and the second upper plating layer 34b₃ is preferably about 2 μm or more and about 7 μm or less, for example.

### (3) Measurements of Two-terminal Multilayer Ceramic Capacitor

A measurement of the two-terminal multilayer ceramic capacitor 10 including the multilayer body 12 and the outer electrode 30 in the length direction z is defined as an L measurement, a measurement of the two-terminal multilayer ceramic capacitor 10 including the multilayer body 12 and the outer electrode 30 in the height direction x is defined as a T measurement, and a measurement of the two-terminal multilayer ceramic capacitor 10 including the multilayer body 12 and the outer electrode 30 in the width direction y is defined as a W measurement.

Example measurements of the two-terminal multilayer ceramic capacitor 10 are preferably such that the L measurement in the length direction z is about 0.2 mm or more and about 3.2 mm or less, the T measurement in the height direction x is about 0.04 mm or more and about 2.5 mm or less, and the W measurement in the width direction y is about 0.1 mm or more and about 2.5 mm or less. Even when the T measurement is about 60 μm or less, the two-terminal multilayer ceramic capacitor 10 according to the present example embodiment is able to effectively reduce a crack. The measurements of the two-terminal multilayer ceramic capacitor 10 can be measured under a microscope.

### 2. Mounting Structure of Multilayer Ceramic Capacitor

Next, a multilayer ceramic capacitor mounting structure 40 according to an example embodiment of the present invention will be described.

FIG. 8 is a side view of an example of a mounting structure of the two-terminal multilayer ceramic capacitor according to an example embodiment of the present invention.

In the present example embodiment, as illustrated in FIG. 8, the second main surface 12b of the two-terminal multilayer ceramic capacitor 10 is a mounting surface for a mounting substrate 42. FIG. 8 is a side view illustrating an example of the two-terminal multilayer ceramic capacitor 10 mounted on the mounting substrate 42 using solder. Referring to FIG. 8, a pair of planar lands 44 to mount the two-terminal multilayer ceramic capacitor 10 are formed on the mounting substrate 42. The two-terminal multilayer ceramic capacitor 10 is configured such that, in a state that the second main surface 12b faces a mounting surface of the mounting substrate 42 and the first main surface 12a is positioned farthest from the mounting surface, the first outer electrode 30a and the second outer electrode 30b are positioned on the pair of lands 44, respectively. With the state above, a solder 46 is applied to the first external electrode 30a and the second external electrode 30b to mount the two-terminal multilayer ceramic capacitor 10 on the mounting substrate 42.

The first outer electrode 30a is provided on the surface of the first end surface 12e in addition to a portion the second main surface 12b being the mounting surface. In the same way, the second outer electrode 30b is provided on the surface of the second end surface 12f in addition to a portion the second main surface 12b being the mounting surface.

In FIG. 8, the two-terminal multilayer ceramic capacitor 10 is mounted on a surface (upper surface) of the mounting substrate 42 such that the second main surface 12b faces the surface of the mounting substrate 42. The case of turning FIG. 8 upside down is also included in possible modes of the mounting structure of the two-terminal multilayer ceramic capacitor. That is, the two-terminal multilayer ceramic capacitor 10 may be mounted on a back surface (lower surface) of the mounting substrate 42 such that the second main surface 12b faces the back surface of the mounting substrate 42.

### 3.2 Method of Manufacturing Two-Terminal Multilayer Ceramic Capacitor

Next, a non-limiting example of a method of manufacturing the two-terminal multilayer ceramic capacitor 10 will be described.

First, a dielectric sheet for a ceramic layer and a conductive paste for an inner electrode layer are prepared. The dielectric sheet and the conductive paste for the inner electrode layer includes a binder and a solvent. The binder and the solvent may be a known organic binder, a known organic solvent, or the like.

The conductive paste for the inner electrode layer is printed on the dielectric sheet in a predetermined pattern by screen printing, gravure printing, or the like, for example. Thus, prepared is the dielectric sheet on which a pattern of a first inner electrode layer and a pattern of a second inner electrode layer are formed.

Further, prepared is the dielectric sheet for an outer layer on which the pattern of the inner electrode layer is not printed. Next, the predetermined number of the dielectric sheets for the outer layer are laminated to form a portion to be a second main surface side outer layer portion on the side of the second main surface. Thereafter, the dielectric sheet on which the pattern of the first inner electrode layer is printed, and the dielectric sheet on which the pattern of the second inner electrode layer is printed are sequentially laminated on the portion to be the second main surface side outer layer portion, to obtain the structure according to an example embodiment of the present invention. Thus, a portion to be the inner layer portion is formed. The predetermined number of the dielectric sheets for the outer layer are laminated on the portion to be the inner layer portion to form a portion to be a first main surface side outer layer portion on the side of the first main surface. Thus, a multilayer sheet is manufactured.

Next, the multilayer sheet is pressed in the lamination direction by an isostatic press or the like, thus manufacturing a multilayer block.

The multilayer block is cut into a predetermined size to singulate a multilayer chip. At this time, a corner portion and a ridge portion of the multilayer chip may be rounded by barrel polishing or the like.

The multilayer chip is fired to manufacture the multilayer body 12. The firing temperature is preferably about 900° C. or more and about 1400° C. or less, for example, depending on the materials of the ceramic layer being dielectric and the inner electrode layer.

Next, the first thin film layer 32a of the first outer electrode 30a is formed on the second main surface 12b and the first end surface 12e of the multilayer body 12 obtained by firing, and the second thin film layer 32b of the second outer electrode 30b is formed on the second main surface 12b and the second end surface 12f of the multilayer body 12.

The first thin film layer 32a and the second thin film layer 32b can be formed at positions where the first outer electrode 30a and the second outer electrode 30b are to be formed, by a thin film forming method such as a sputtering method or a vapor deposition method performing masking or the like to the multilayer body 12. The thin film layer 32 is a layer of about 1 μm or less, for example, in which metal particles are deposited.

At this time, the first thin film layer 32a and the second thin film layer 32b are formed such that the thicknesses of the first continuous thin film layer 32a₃ and the second continuous thin film layer 32b₃ are smaller than the thicknesses of the first end surface thin film layer 32a₂ and the second end surface thin film layer 32b₂, respectively. In the present example embodiment, the first continuous thin film layer 32a₃ and the second continuous thin film layer 32b₃ are formed such that the thicknesses thereof in the length direction z become smaller toward the first main surface 12a.

When a PVD method such as a sputtering method is used, the thickness of the thin film layer 32 is controlled by changing the mode in which ions such as argon ions are ejected toward a target. When the first thin film layer 32a and the second thin film layer 32b are deposited with the target and the second main surface 12b facing each other, the film thickness of each of the first end surface 12e and the second end surface 12f becomes smaller than that of the second main surface 12b.

Further, the thickness can be controlled by changing a distance to the target. Specifically, the distance between the target and respective portions where the first continuous thin film layer 32a₃ and the second continuous thin film layer 32b₃ are to be formed is made larger than the distance between the target and each of portions where the first end surface thin film layer 32a₂ and the second end surface thin film layer 32b₂ are to be formed. By making the distance from the target larger, the thicknesses of the first continuous thin film layer 32a₃ and the second continuous thin film layer 32b₃ can be smaller than the thicknesses of the first end surface thin film layer 32a₂ and the second end surface thin film layer 32b₂, respectively.

The thickness can also be controlled by a disposing method of a surface of the target (target surface) relative to the multilayer body 12. For example, the target is disposed such that the target surface is perpendicular to the second main surface 12b of the multilayer body 12. Thus, the region where the target is deposited by sputtering is expanded outward, and in this state, a metal extracted from the target is deposited on the multilayer body 12, such that the thickness of the thin film layer 32 can be controlled.

The thickness can be controlled by controlling a deposition rate with the control of degree of vacuum in the PVD apparatus. Specifically, the film thickness can be made larger by increasing the deposition rate with an increase of the degree of vacuum, or the film thickness can be made smaller by decreasing the deposition rate with a decrease of the degree of vacuum.

The thin film layer 32 can be formed of a desired metal by using different types of target. For example, the thin film layer 32 configured of different types of metal can be formed by sequentially installing multiple types of target and performing sputtering.

Next, the plating layer 34 is formed. The plating layer 34 is formed on the surface of the thin film layer 32. Further, the plating layer 34 may be formed directly on the multilayer body 12. In the present example embodiment, a Cu plating layer is formed as a lower plating layer on the thin film layer 32, a Ni plating layer is formed as an intermediate plating layer, and an Sn plating layer is formed as an upper plating layer. The Cu plating layer, the Ni plating layer, and the Sn plating layer are sequentially formed by, for example, a barrel plating method. The plating treatment may be performed by electrolytic plating or electroless plating. Note that, the electroless plating requires pretreatment with a catalyst or the like in order to increase a plating deposition rate, and thus has a disadvantage of complicating a process. Accordingly, it is preferable to use the electrolytic plating in a usual case.

As described above, the two-terminal multilayer ceramic capacitor 10 according to the present example embodiment is manufactured.

Although example embodiments of the present invention have been disclosed in the above description, the present invention is not limited to the example embodiments.

That is, various modifications can be made to the above-described example embodiments in terms of mechanism, shape, material, quantity, position, disposition, and the like without departing from the scope of the present invention, and such modifications are included in the scope of the present invention.

A modification of the present example embodiment will be described. In the present modification, the same reference numerals are given to the same elements as those of the above-described example embodiments, and the detailed description thereof will be omitted.

### (A)

In the above-described example embodiments, the first outer electrode 30a is provided on the surfaces of a portion the second main surface 12b and the first end surface 12e. The first outer electrode 30a is not limited to the above, and may extend from the first end surface 12e to be located on a portion the second main surface 12b, a portion the first side surface 12c, and a portion the second side surface 12d. In this case, the thin film layer 32 may extend from the first end surface 12e to be located on a portion the second main surface 12b, a portion the first side surface 12c, and a portion the second side surface 12d.

Specifically, the first main surface thin film layer 32a₁ may extend from the first end surface 12e to be located on a portion the second main surface 12b, a portion the first side surface 12c, and a portion the second side surface 12d. The first end surface thin film layer 32a₂ may extend from the first end surface 12e to be located on a portion the first side surface 12c and a portion the second side surface 12d. The first continuous thin film layer 32a₃ may be continuous with the first end surface thin film layer 32a₂, and may extend from the first end surface 12e to be located on a portion the first side surface 12c and a portion the second side surface 12d. In this case, the first plating layer 34a may extend from the first end surface 12e to be located on a portion the second main surface 12b, a portion the first side surface 12c, and a portion the second side surface 12d so as to cover the first main surface thin film layer 32a₁, the first end surface thin film layer 32a₂, and the first continuous thin film layer 32a₃.

In the same way, in the above-described example embodiment, the second outer electrode 30b is provided on surfaces of a portion the second main surface 12b and the second end surface 12f. The second outer electrode 30b is not limited to the above, and may extend from the second end surface 12f to be located on a portion the second main surface 12b, a portion the first side surface 12c, and a portion the second side surface 12d. In this case, the thin film layer 32 may extend from the second end surface 12f to be located on a portion of the second main surface 12b, a portion the first side surface 12c, and a portion the second side surface 12d.

Specifically, the second main surface thin film layer 32b₁ may extend from the second end surface 12f to be located on a portion the second main surface 12b, a portion the first side surface 12c, and a portion the second side surface 12d. The second end surface thin film layer 32b₂ may extend from the second end surface 12f to be located on a portion the first side surface 12c and a portion the second side surface 12d. The second continuous thin film layer 32b₃ may be continuous with the second end surface thin film layer 32b₂, and may extend from the second end surface 12f to be located on a portion the first side surface 12c and a portion the second side surface 12d. In this case, the second plating layer 34b may extend from the second end surface 12f to be located on a portion the second main surface 12b, a portion the first side surface 12c, and a portion the second side surface 12d so as to cover the second main surface thin film layer 32b₁, the second end surface thin film layer 32b₂, and the second continuous thin film layer 32b₃.

### (B)

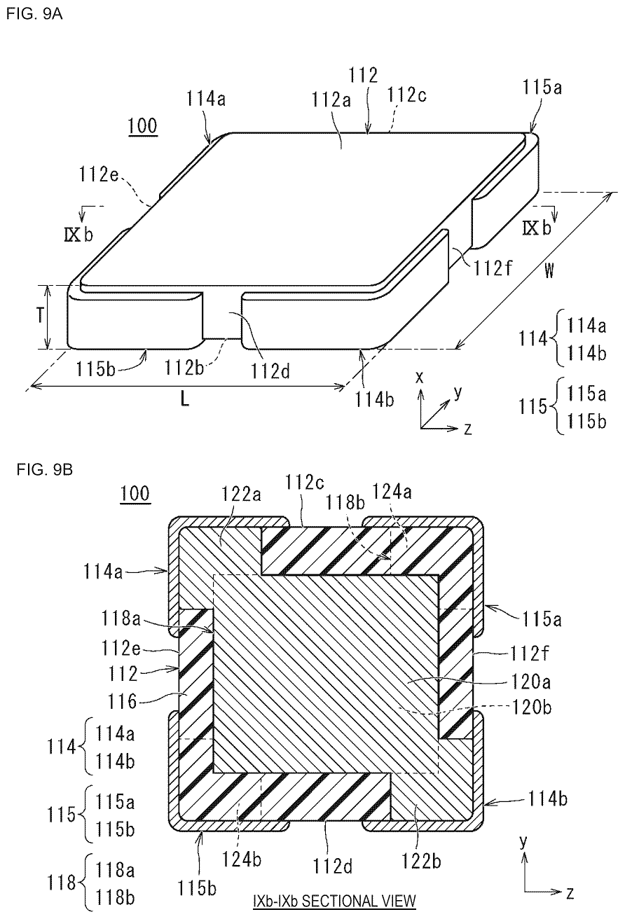

In the above-described example embodiments, the L measurement and the W measurement of the two-terminal multilayer ceramic capacitor 10 are different from each other. However, the L measurement and the W measurement may be the same. This specific example will be described with reference to FIGS. 9A and 9B. FIG. 9A is an external perspective view of a multilayer ceramic capacitor according to a modification of an example embodiment of the present invention, and FIG. 9B is a sectional view of the multilayer ceramic capacitor in FIG. 9A taken along a line IXb-IXb.

A multilayer ceramic capacitor 100 according to the modification includes a rectangular parallelepiped multilayer body 112 and outer electrodes 114 and 115.

The multilayer body 112 includes multiple ceramic layers 116 and multiple inner electrode layers 118. The multilayer body 112 includes a first main surface 112a and a second main surface 112b opposed to each other in the lamination direction x, a first side surface 112c and a second side surface 112d opposed to each other in the width direction y orthogonal to the lamination direction x, and a third side surface 112e and a fourth side surface 112f opposed to each other in the length direction z orthogonal to the lamination direction x and the width direction y.

The multilayer body 112 includes multiple first inner electrode layers 118a and multiple second inner electrode layers 118b as the multiple inner electrode layers 118. The first inner electrode layer 118a and the second inner electrode layer 118b are alternately laminated with the ceramic layer 116 interposed therebetween.

The first inner electrode layer 118a is provided on a surface of the ceramic layer 116. The first inner electrode layer 118a includes a first facing portion 120a facing the first main surface 112a and the second main surface 112b, and is laminated in a direction coupling the first main surface 112a and the second main surface 112b.

The second inner electrode layer 118b is provided on a surface of the ceramic layer 116 different from the ceramic layer 116 on which the first inner electrode layer 118a is located. The second inner electrode layer 118b includes a second facing portion 120b facing the first main surface 112a and the second main surface 112b, and is laminated in the direction coupling the first main surface 112a and the second main surface 112b.

The first inner electrode layer 118a is extended to the first side surface 112c and the third side surface 112e of the multilayer body 112 by a first extended portion 122a, and is extended to the second side surface 112d and the fourth side surface 112f of the multilayer body 112 by a second extended portion 122b.

The second inner electrode layer 118b is extended to the first side surface 112c and the fourth side surface 112f of the multilayer body 112 by a third extended portion 124a, and is extended to the second side surface 112d and the third side surface 112e of the multilayer body 112 by a fourth extended portion 124b.

The outer electrode 114 includes a first outer electrode 114a electrically coupled to the first extended portion 122a of the first inner electrode layer 118a, and a second outer electrode 114b electrically coupled to the second extended portion 122b.

The first outer electrode 114a covers the first extended portion 122a on the first side surface 112c and the third side surface 112e, and covers a portion the second main surface 112b. The second outer electrode 114b covers the second extended portion 122b on the second side surface 112d and the fourth side surface 112f, and covers a portion the second main surface 112b.

The outer electrode 115 includes a third outer electrode 115a electrically coupled to the third extended portion 124a of the second inner electrode layer 118b, and a fourth outer electrode 115b electrically coupled to the fourth extended portion 124b.

The third outer electrode 115a covers the third extended portion 124a on the first side surface 112c and the fourth side surface 112f, and covers a portion the second main surface 112b. The fourth outer electrode 115b covers the fourth extended portion 124b on the second side surface 112d and the third side surface 112e, and covers a portion the second main surface 112b.

The first outer electrode 114a, the second outer electrode 114b, the third outer electrode 115a, and the fourth outer electrode 115b each include the same thin film layers as those of the above-described example embodiment. The thin film layer includes a main surface thin film layer on a portion the second main surface 112b, an end surface thin film layer on each of the first to fourth side surfaces 112c to 112f, and a continuous thin film layer continuously extending from the end surface thin film layer to a side of the first main surface 112a in the lamination direction x.

In the multilayer ceramic capacitor 100, the L measurement and the W measurement are preferably the same, for example.

The inner electrode layer 118 is continuously exposed on two adjacent side surfaces of the multilayer body 112, but may be exposed on one side surface.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component, comprising:
a multilayer body including multiple laminated ceramic layers, a first main surface and a second main surface opposed to each other in a height direction, a first end surface and a second end surface opposed to each other in a length direction orthogonal to the height direction, and a first side surface and a second side surface opposed to each other in a width direction orthogonal to the height direction and the length direction;
multiple first inner electrode layers on the multiple ceramic layers and extended to the first end surface;
multiple second inner electrode layers on the multiple ceramic layers and extended to the second end surface;
a first outer electrode on the first end surface, extending from the first end surface to be located on a portion of the second main surface, and coupled to the first inner electrode layers; and
a second outer electrode on the second end surface, extending from the second end surface to be located on a portion of the second main surface, and coupled to the second inner electrode layers; wherein
each of the first outer electrode and the second outer electrode includes a thin film layer and a plating layer on the thin film layer;
the thin film layer of each of the first outer electrode and the second outer electrode includes:
a main surface thin film layer on at least a portion of the second main surface of the multilayer body;
an end surface thin film layer on at least a portion of a corresponding one of the first end surface and the second end surface of the multilayer body; and
a continuous thin film layer extending continuously with the end surface thin film layer in the height direction; and
a thickness of the continuous thin film layer in the length direction is smaller than a thickness of the end surface thin film layer in the length direction.

2. The multilayer ceramic electronic component according to claim 1, wherein the main surface thin film layer of each of the first outer electrode and the second outer electrode continuously extends from the second main surface to a portion of the first end surface and a portion of the second end surface, respectively.

3. The multilayer ceramic electronic component according to claim 1, wherein the continuous thin film layer is closer to the first main surface of the multilayer body than the first inner electrode layers and the second inner electrode layers.

4. The multilayer ceramic electronic component according to claim 1, wherein a length of the continuous thin film layer in the height direction is about twice or more and about five times or less a thickness of the end surface thin film layer in the length direction.

5. The multilayer ceramic electronic component according to claim 1, wherein the thickness of the continuous thin film layer in the length direction decreases toward the first main surface.

6. The multilayer ceramic electronic component according to claim 1, wherein the thickness of the continuous thin film layer in the length direction is about 20 nm or more and about 100 nm or less.

7. The multilayer ceramic electronic component according to claim 1, wherein
the plating layer includes a lower plating layer on the thin film layer, an intermediate plating layer on the lower plating layer, and an upper plating layer on the intermediate plating layer;
the lower plating layer is a Cu plating layer;
the intermediate plating layer is a Ni plating layer; and
the upper plating layer is a Sn plating layer.

8. The multilayer ceramic electronic component according to claim 1, wherein the main surface thin film layer includes at least either one of Cr and Ti.

9. The multilayer ceramic electronic component according to claim 1, wherein the end surface thin film layer includes at least either one of Ni and Cu.

10. The multilayer ceramic electronic component according to claim 1, wherein the continuous thin film layer includes at least either one of Ni and Cu.

11. A multilayer ceramic electronic component, comprising:
a multilayer body including a first main surface and a second main surface opposed to each other in a height direction, a first side surface and a second side surface opposed to each other in a width direction orthogonal or substantially orthogonal to the height direction, and a third side surface and a fourth side surface opposed to each other in a length direction orthogonal or substantially orthogonal to the height direction and the width direction;
a first outer electrode on the first side surface and the third side surface, and extending from the first side surface to a portion of the second main surface;
a second outer electrode on the second side surface and the fourth side surface, and extending from the second side surface to a portion of the second main surface;
a third outer electrode on the first side surface and the fourth side surface, and extending from the first side surface to a portion of the second main surface;
a fourth outer electrode on the second side surface and the third side surface, and extending from the second side surface to be located on a portion of the second main surface; wherein
a measurement of multilayer ceramic electronic component in the length direction and a measurement of multilayer ceramic electronic component in the width direction are the same or substantially same;
each of the first outer electrode and the second outer electrode includes a thin film layer and a plating layer on the thin film layer;
the thin film layer of each of the first outer electrode and the second outer electrode includes:
a main surface thin film layer on at least a portion of the second main surface of the multilayer body;
an end surface thin film layer on at least a portion of a corresponding one of the first side surface and the second side surface of the multilayer body; and
a continuous thin film layer extending continuously with the end surface thin film layer in the height direction; and
a thickness of the continuous thin film layer in the length direction is smaller than a thickness of the end surface thin film layer in the length direction.

12. The multilayer ceramic electronic component according to claim 11, wherein the main surface thin film layer of each of the first outer electrode and the second outer electrode continuously extends from the second main surface to a portion of the first side surface and a portion of the second side surface, respectively.

13. The multilayer ceramic electronic component according to claim 11, wherein the continuous thin film layer is closer to the first main surface of the multilayer body than a first inner electrode layers and a second inner electrode layers.

14. The multilayer ceramic electronic component according to claim 11, wherein a length of the continuous thin film layer in the height direction is about twice or more and about five times or less a thickness of the end surface thin film layer in the width direction.

15. The multilayer ceramic electronic component according to claim 11, wherein the thickness of the continuous thin film layer in the width direction decreases toward the first main surface.

16. The multilayer ceramic electronic component according to claim 11, wherein the thickness of the continuous thin film layer in the width direction is about 20 nm or more and about 100 nm or less.

17. The multilayer ceramic electronic component according to claim 11, wherein the main surface thin film layer includes at least one of Cr or Ti.

18. The multilayer ceramic electronic component according to claim 11, wherein the end surface thin film layer includes at least one of Ni or Cu.

19. The multilayer ceramic electronic component according to claim 11, wherein the continuous thin film layer includes at least one of Ni or Cu.
